(19) United States
(12) Patent Application Publication
(10) Pub. No.: US 2007/0054248 A1
(43) Pub. Date: Mar. 8, 2007

(54) Systems and Methods for Standardizing Employment Skill Sets for Use in Creating, Searching, and Updating Job Profiles

(76) Inventor: Warren Lee Bare, Duluth, GA (US)

Correspondence Address: SUTHERLAND ASBILL & BRENNAN LLP, 999 PEACHTREE STREET, N.E., ATLANTA, GA, 30309, US

(21) Appl. No.: 11/464,860

(22) Filed: Aug. 16, 2006

Related U.S. Application Data
(60) Provisional application No. 60/708,868, filed on Aug. 17, 2005.

(51) Int. Cl. G09B 19/00

(52) U.S. Cl. 434/219

(57) ABSTRACT

Embodiments of the present invention may provide systems and methods for standardizing employment skill sets. In accordance with such embodiments of the present invention, job applicants may create profiles that specify a plurality of skills, where each profile or at least a portion thereof will be accessible by a host server. The host server, an in particular a host module, analyzes stored profiles for commonalities in order to determine relationships, friendships, or affinities between particular skills. Based upon the determined relationships, friendships, or affinities between or among particular skills, the host server is able to dynamically suggest related skills based on the current skills and abilities being provided by a job applicant when creating a profile. As new relationships are strengthened or old relationships are weakened based upon the stored profiles, the host server adapts to suggest new skills based on those already provided by the current job applicant. Thus, job applicants are able to select these suggested skills, or alternatively, may create new skills if the desired ones are not suggested. Likewise, recruiters can select these suggested skills or specify new skills when searching profiles for qualified job applicants.

### RELATED APPLICATIONS

The present invention claims benefit of U.S. Provisional Application Ser. No. 60/708,868, filed Aug. 17, 2005, and entitled “Systems and Methods for Employment Search Capabilities Utilizing Dynamic Relationships Between Skills and Abilities,” which is hereby incorporated by reference in its entirety.

### FIELD OF THE INVENTION

The present invention relates generally to employment skill sets, and more particularly, to systems and methods for standardizing employment skill sets to provide enhanced, flexible job-ralted search capabilities.

### BACKGROUND OF THE INVENTION

Employers spend a tremendous amount of resources each year attempting to find qualified applicants to fill needed positions and roles within their companies. In order to fill these needed roles, employers typically resort to three methods—(1) job listings, (2) Internet resume databases, and (3) recruiters. All of these methods have significant disadvantages as will be described below.

First, many employers post job listings in a variety of sources including traditional newspapers and Internet job databases. These newspapers and Internet job databases promise to provide these employers with a significant number of responses and resumes for a relatively small fee. This small fee, however, pales in comparison to the large time and costs that companies will expend to sort through the large numbers of resumes received. In particular, of the large number of resumes received, only a small number, perhaps only about 5%, of these resumes will meet the employer's criteria. Of perhaps 1000 resumes received, an employer may only find approximately 50 pertinent resumes Thus, many employers oftentimes have recruiting departments that spend a large amount of time sifting through piles of resumes. Accordingly, this process of finding these small number of pertinent resumes is burdensome and costly to employers.

Second, many employers may utilize Internet resume databases to search for qualified applicants For a relatively low cost, these Internet resume databases typically allow employers to search for keywords on resumes in the database. However, these searches performed by employers are extremely limiting because they depend on the applicants themselves to utilize the same keywords as the employers performing the searches. More specifically, a problem arises because of the vast numbers of skill sets and the numerous variations of expressing and searching those skill sets. In other words, previous methods have not provided a standardized way of managing the vast number of skill sets such that applicants and employers will utilize the same terminology when specifying equivalent skill sets. Therefore, with these previous methods, qualified applicants who do not utilize certain keywords on their resumes may be overlooked by certain employers. On the other hand, unqualified applicants may intentionally place misleading keywords in their resumes to trick employers into reading their resumes. This is also not desirable. Thus, this process of searching in Internet resume databases can also be burdensome and costly to employers.

Third, many employers who have unsuccessfully tried job postings and Internet resume databases oftentimes turn to personal recruiters. Because these recruiters personally perform the selection process for the employers, this reduces the number of applicants that an employer must review to find the qualified pool of applicants. While employers appreciate the ease of finding qualified applicants, they pay a hefty price for this convenience. For example, payments of twenty-five percent of an employee's first year salary to recruiters are fairly common. Thus, while recruiters may be effective, they are also very expensive.

Accordingly, there is a need in the industry for a lower-cost more efficient, effective, and consistent means for employees to specify their skills sets and for employers to locate qualified applicants with certain skill sets.

### SUMMARY OF THE INVENTION

According to an embodiment of the present invention, there is a method for standardizing employment skill sets. The method includes storing a plurality of profiles in a database, where each profile provides a plurality of skills associated with a previous job applicant, receiving a first skill from a current job applicant, and searching the stored profiles in the database for profiles that include the first skill. The method further includes determining at least one second skill in at least a portion of the profiles having the first skill, where the second skill is different from the first skill.

According to an aspect of the present invention, the method may further include presenting at least a portion of the at least one determined second skill to the current job applicant in response to the received first skill. According to another aspect of the present invention, receiving a first skill from a current job applicant may include receiving the first skill from a resume uploaded by the current job applicant. According to yet another aspect of the present invention, determining at least one second skill may include determining a plurality of second skills. Additionally, the method may further include ordering the plurality of determined second skills by a strength of relationship between each determined second skill and the first skill. The strength of relationship may be associated with a correlation value between each determined second skill and the first skill. The strength of relationship may also be aged according to time. In addition or in the alternative, the strength of relationship may be associated with each determined second skill appearing with the first skill in at least one of a particular number of stored profiles and a particular percentage of stored profiles.

According to another embodiment of the present invention, there is a computerized employment system for standardizing employment skill sets. The system includes a database that stores a plurality of profiles, where each profile provides a plurality of skills associated with a previous job applicant and a host module. The host module is configured to receive a first skill from a current job applicant, search the stored profiles in the database for profiles that include the first skill, and determine at least one second skill in at least a portion of the stored profiles having the first skill, where the second skill is different from the first skill.

According to an aspect of the present invention, the host module may be further configured to present at least a portion of the at least one determined second skill to the current job applicant in response to the received first skill. According to another aspect of the present invention, the first skill may be received from a resume uploaded by the job applicant. According to another aspect of the present invention, the at least one determined second skill may include a plurality of determined second skills. According to yet another aspect of the present invention, the host module may be further configured to order the plurality of second skills by a strength of relationship between each determined second skill and the first skill. The strength of relationship may be associated with a correlation value between each second skill and the first skill. The strength of relationship may be aged according to time. In addition or in the alternative, the strength of relationship may be associated with each determined second skill appearing with the first skill in at least one of a particular number of stored profiles and a particular percentage of stored profiles.

According to yet another embodiment of the present invention, there is a method for identifying qualified job applicants. The method includes storing a plurality of profiles in a database, where each profile includes a plurality of skills associated with a previous job applicant selecting a first skill by a recruiter, and searching the stored profiles in the database for profiles that include the first skill. The method further includes determining at least one second skill in at least a portion of the profiles having the first skill, where the second skill is different from the first skill, selecting at least one determined second skill by the recruiter, and identifying at least one stored profile based at least in part on the selected first skill and selected second skill.

According to an aspect of the present invention, the profiles further may further include at least one of a preferred geographical area, a salary preference, a work schedule preference, and a benefits preference for the previous job applicant. According to another aspect of the present invention, identifying at least one stored profile may include identifying at least one stored profile based at least in part on at least one of the preferred geographical area, the salary preference, the work schedule preference, and the benefits preference. According to yet another aspect of the present invention, the method may further include means for anonymous communications between the recruiter and at least one previous job applicant associated with the identified at least one stored profile.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows an overview of an employment system according to an illustrative embodiment of the invention.

FIG. 2 shows a block diagram for a job applicant interacting with an employment system according to an illustrative embodiment of the present invention.

FIG. 3 shows a block diagram for determining related skills and abilities according to an illustrative embodiment of the present invention.

FIGS. 4-7 show exemplary user interfaces for job applicants interacting with the employment system according to an illustrative embodiment of the present invention.

FIG. 8 shows a block diagram for a recruiter interacting with an employment system according to an illustrative embodiment of the present invention.

### DETAILED DESCRIPTION OF THE INVENTION

Embodiments of the present invention may provide systems and methods for standardizing and managing a vast number of employment-related skills sets. As described in further detail below, these skill sets may change over time or new skill sets may be created. Accordingly, embodiments of the present invention may dynamically manage these changing skill sets, and present them to job applicants and recruiters (e.g., a third-party entity of a hiring company or the hiring company itself) in a standardized way. Thus, in accordance with embodiments of the present invention job applicants may create stored profiles that recite standardized skill sets. Because recruiters also have access to the same standardized skill sets, these recruiters can easily located qualified applicants based upon specifying equivalent standardized skill sets. In other words, embodiments of the present invention provide means for standardizing skill sets such that job applicants can specify these standardized skill sets while recruiters can search for these job applicants using the same standardized skill sets.

In accordance with embodiments of the present invention, job applicants may utilize one or more client computers to communicate with one or more host servers. Each of these job applicants may create profiles that specify their skills and abilities, where each profile or at least a portion thereof will be stored on one or more host servers and/or databases accessible by the host servers. The host server analyzes stored profiles for commonalities in order to determine relationships, friendships, or affinities between particular skills and abilities. Based upon the determined relationships, friendships, or affinities between or among particular skills and abilities, the host server is able to dynamically suggest related skills and abilities based on the current skills and abilities being provided by a job applicant when creating a profile. In other words, as new relationships are strengthened or old relationships are weakened based upon the stored profiles, the host server adapts to suggest new skills and abilities based on those already provided by the current job applicant. Thus, job applicants are able to select these suggested skills and abilities, or alternatively, may create new skills and abilities if the desired ones are not suggested. If job applicants include new skills and abilities, these new skills and abilities may potentially be suggested to other job applicants when the host server determines that a strong enough relationship exists between this new skill and ability and other known skills and abilities based upon the existing set of stored profiles.

By providing job applicants with suggested skills and abilities or the capability to create new ones, the host server allows job applicants to create customized profiles that are far more likely to be complete and accurate. Likewise, the use of suggested skills and abilities that are relatable to other skills and abilities generally allows the creation of profiles that are more coherent and consistent. This consistency and coherency in profiles also allows recruiters to more easily locate qualified job applicants. In particular, as recruiters enter required skills and abilities, the host server also suggests related skills and abilities that are likely to be found in job applicants' profiles. Thus, recruiters will be able to compile a list of desired skills and abilities that are likely to be found in the stored profiles, and the profiles of the qualified applicants can be determined.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention is described below with reference to block diagrams and flowchart illustrations of systems, methods, apparatuses and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

I. Overview of the Employment System

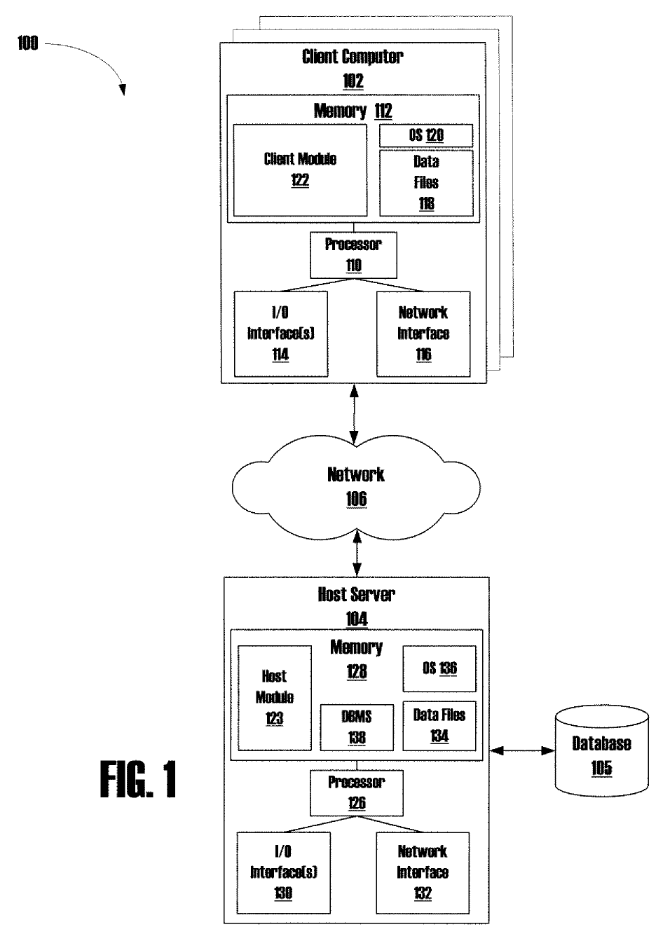

Exemplary embodiments of the present invention will hereinafter be described with reference to the figures, in which like numerals indicate like elements throughout the several drawings. FIG. 1 shows a block diagram of an interactive employment system 100 according to one aspect of the present invention. In particular, the interactive employment system 100 of FIG. 1 includes one or more client computers 102 and one or more host servers 104, which are each configured for accessing and reading associated computer-readable media having stored thereon data and/or computer-executable instructions for implementing the various methods of the present invention. Generally, network devices and systems, including the one or more client computers 102 and host servers 104, have hardware and/or software for transmitting and receiving data and/or computer-executable instructions over a communications link and a memory for storing data and/or computer-executable instructions. These network devices and systems may also include a processor for processing data and executing computer-executable instructions, as well as other internal and peripheral components that are well known in the art. As used herein, the term “computer-readable medium” describes any form of memory or a propagated signal transmission medium. Propagated signals representing data and computer-executable instructions are transferred between network devices and systems.

As shown in FIG. 1, a client computer 102 may be in communication with the host server 104 via a network 106. Each of these three components—the client computer 102, the host server 104, and the network 106—will now be discussed in turn. First, the client computer 102 may be any processor-driven device, such as a personal computer, laptop computer, handheld computer and the like. In addition to having a processor 110, the client computer 102 may further include a memory 112, input/output (“I/O”) interface(s) 114 and a network interface 116. The memory 112 may store data files 118 and various program modules, such as an operating system (“OS”) 120 and a client module 122. The client module 122 may be an Internet browser or other software, including a dedicated program, for interacting with host server 104. For example, job applicants may utilize the client module 122 to interact with the host server 104 when entering personal information and other information relating to employment desires, needs, and skills or abilities. Similarly, recruiters may utilize the client module 122 to interact with the host server 104 to search for and locate qualified applicants based upon employment desires, needs, and skills or abilities.

Still referring to the client computer 102, the I/O interface(s) 114 facilitate communication between the processor 110 and various I/O devices, such as a keyboard, mouse, printer, microphone, speaker, monitor, and the like. The network interface 116 may take any of a number of forms, such as a network interface card, a modem, a wireless network card, and the like. These and other components of the client computer 102 will be apparent to those of ordinary skill in the art and are therefore not discussed in more detail herein.

Second, similar to the client computer 102, the host server 104 may be any processor-driven device that is configured for receiving and fulfilling requests from the client computer 102 related to employment storage and search transactions. The host server 104 may therefore include a processor 126, a memory 128, input/output (“I/O”) interface(s) 130 and a network interface 132. The memory 128 may store data files 134 and various program modules, such as an operating system (“OS”) 136, a database management system (“DBMS”) 138 and the host module 123. The host module 123 receives, processes, and responds to requests from the client module 122 of client computer 102, which may be operated by a job applicant or a recruiter. The host server 104 may include additional program modules for performing other pre-processing or post-processing methods described herein. Those of ordinary skill in the art will appreciate that the host server 104 may include alternate and/or additional components, hardware or software.

As illustrated in FIG. 1, the host server 104 may include or be in communication with one or more database(s) 105. The database 105 may store, for example, job applicants' profiles that includes personal information, needs and desires, and skills and abilities. The database 105 may also store terms and phrases used to describe employment skills and abilities and relationships, including strength or “heat” of relationships, between or among these terms and phrases. In addition, the database 105 may also keep track of common terms and phrases utilized by job applicants in describing their skills and abilities along with the frequency of use of those terms and phrases. One of ordinary skill in the art will recognize that other data relating to job applicants and recruiters needed to carry out the processing methods described herein will be stored in database 105 as needed. Although a single database 105 is referred to herein for simplicity, those skilled in the art will appreciate that multiple physical and/or logical databases may be used to store the above mentioned data For security and performance purposes, the host server 104 may have a dedicated connection to the database 105. however, the host server 104 may also communicate with the database 105 via a network 106, as shown. In other embodiments of the invention, the host server 104 may include the database 105 locally. The host server 104 may also otherwise be part of a distributed or redundant DBMS.

Third, the network 106 may include any telecommunication and/or data network, whether public, private, or a combination thereof, including a local area network, a wide area network, an intranet, an internet, the Internet, and/or any combination thereof and may be wired and/or wireless. Due to network connectivity, various methodologies as described herein may be practiced in the context of distributed computing environments. Although the client computer 102 is shown for simplicity as being in communication with the host server 104 via one intervening network 106, it is to be understood that any other network configuration is possible. For example, intervening network 106 may include a plurality of networks, each with devices such as gateways and routers for providing connectivity between or among networks 106. Instead of or in addition to a network 106, dedicated communication links may be used to connect the various devices of the present invention.

Those of ordinary skill in the art will appreciate that the employment system 100 shown in and described with respect to FIG. 1 is provided by way of example only. Numerous other operating environments, system architectures, and device configurations are possible. Accordingly, the present invention should not be construed as being limited to any particular operating environment, system architecture, or device configuration.

II. Operation of the Employment System with Job Applicants

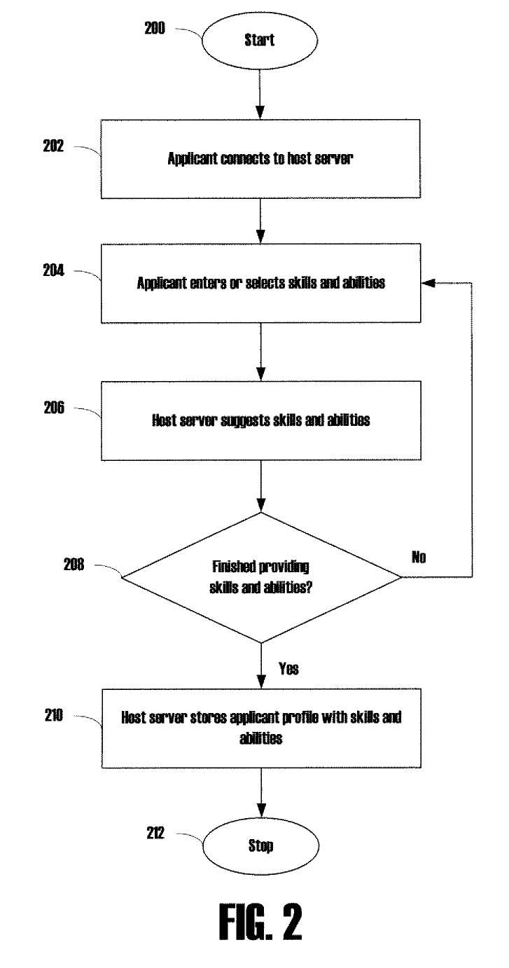

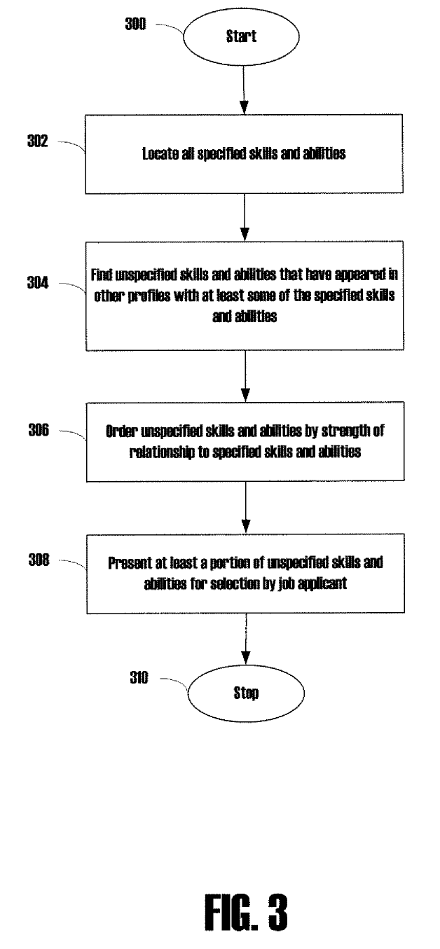

Having described the employment system 100 of FIG. 1 generally, the operation of the employment system 100 will now be described in more detail with respect to the block diagrams of FIGS. 2 and 3. In FIG. 2, a job applicant begins by using the client module 122 of the client computer 102 to connect with the host server 104 via network 106 (block 202). In particular, the client module 122 of the client computer 102 may be an Internet browser directed to an interactive web page that is being serviced by the host module 123 of the host server 104 according to an exemplary embodiment. The interactive web page allows the job applicant to create a profile that will include the job applicant's skills and abilities that a recruiter may find helpful in determining the job applicant's qualifications for a particular job.

In creating this profile, the job applicant interacting with the web page may select skills or abilities suggested by the host module 123, or the job applicant can enter his or her own terms and phrases to describe his or her abilities (block 204). Initially, the web page may suggest broad categories for skills or abilities that the job applicant can select from. This initial list of categories for skills or abilities may be determined by the host module 123 by examining the more commonly-entered terms found in stored profiles for other job applicants. In alternative embodiments, at least a portion of this initial list of categories may also be static or preset.

When the job applicant has selected one skill or ability to be included in his or her profile, the host module 123, using at least a portion of the information from profiles stored in the database 105, will suggest and present on the job applicant's web page several more related skills and abilities (block 206). These suggested skills and abilities can be selected by the job applicant, and upon selection, the selected skills and abilities will be included in the job applicant's profile to be stored in the database 105. Alternatively, if the job applicant does not find a desirable skill or ability in the suggested list, then the job applicant can always enter a more appropriate term or terms to describe his or her own skill or ability.

As the job applicant enters or selects more skills or abilities for inclusion in his or her profile, the list of skills or abilities suggested by host module 123 to the job applicant may change based upon the job applicant's list of currently-entered or selected skills and abilities. The method by which the host module 123 determines, according to block 206, the list of suggested skills or abilities to present on the job applicant's web page will now be discussed with reference to the block diagram of FIG. 3.

Referring to FIG. 3, the host module 123 of host server 104 receives the current list of skills or abilities that have been selected by the job applicant on the web page (block 302). Using this list of skills or abilities currently selected by the job applicant, the host module 123 locates other skills or abilities that are related to the selected skills or abilities (block 304). The host module 123 locates the related skills or abilities through analyzing commonalities among the previously-stored job applicants' profiles that also specify selected skills or abilities. In other words, by examining previously-stored profiles in database 105, the host module 123 can make a determination as to how skills or abilities are currently known to be related. Thus, the related skills or abilities may change as the stored profiles and their specified skills or abilities change. This process will now be described in more detail below.

In accordance with an embodiment of the invention, one skill or ability may become related to at least one other skill or ability once it appears together with the other skill or ability in at least a percentage or number of times in the other stored job applicants' profiles. For example, if a particular percentage of the profiles with the skill or ability “Cashier” also contains the skill or ability “Customer Service,” then “Customer Service” may be related to “Cashier.” In addition or in the alternative, if in a number of stored profiles, “Customer Service” appears with “Receptionist,” then the skill or ability of “Customer Service” may be related to the skill or ability “Receptionist.” According to an exemplary embodiment of the present invention, a relationship between two skills or abilities occurs only after a first skill or ability appears with another skill or ability in four other profiles, although this number could be modified without departing from embodiments of the present invention. One of ordinary skill in the art will recognize that this number may also change according to one or more factors, including the number of profiles stored in the database 105. For example, if there are only a small number of profiles stored in database 105, then the predetermined number of times in which one skill or ability must appear with another skill or ability would be lower. By contrast, a database 105 with a large number of profiles may require a larger number of times in which one skill or ability must appear with another skill or ability.

One of ordinary skill in the art will recognize that while relationships, friendships, or affinities have only been described between two skills or abilities, they also equally apply among more than two skills or abilities. For example, based on previous profiles stored in the database 105 of host server 104, the host module 123 may determine that a particular skill or ability typically appears with two other skills or abilities, and therefore only suggests that particular skill or ability when the other two skills or abilities have been selected or entered by the job applicant.

Besides knowing that at least one skill or ability has a relationship (or friendship or affinity) to another skill or ability, the host module 123 may also determine the strength or “heat” of such relationship. The strength of relationships (or friendships or affinities) between skills and abilities may be determined through several varying methods—including through statistical, time, and frequency methods. First, with statistical methods, the differences between the appearance of each skill or ability in all the profiles is statistically compared with the appearance of two skills or abilities with each other (e.g., a correlation). Generally, while each skill or ability may appear in a particular percentage of profiles, the distribution of each skill or ability across profiles is not uniform when terms are related to each other. For example, the skill “Java” may appear in 20% of the total number of profiles stored in the database 105. Within these profiles referring to “Java,” they may be used in differing contexts-such as “Java Programmer” or “I like drinking java.” Another skill such as “Websphere” may appear, for example, in 3% of the total number of profiles. If we did not know beforehand that “Websphere” is a Java product, we might expect to find that only 3% of the profiles that contain the term “Java” contain “Webpshere.” However, in reality, since “Websphere” and “Java” are indeed related-Websphere is a Java product—a significant number of the profiles that have “Java” will also contain “Websphere.” For example, when examining the profiles that have “Java,” the term “Websphere” may appear in 20% of those profiles (“actual percentage”). Accordingly, this 20% (“actual percentage”) for profiles with “Java” is much larger than the expected 3% for all profiles (“expected percentage”), and thus, the term “Websphere” has a strong relationship, friendship, or affinity with the term “Java.” According to an embodiment of the present invention, the larger the difference between the actual percentage and the expected percentage, the larger the correlation and thus the correlation value between skills and abilities. If the difference between the actual percentage and the expected percentage is positive, then there is a positive correlation (e.g., the skills and abilities are related). By contrast, if the difference between the actual percentage and the expected percentage is negative, then there is a negative correlation (e.g., the skills and abilities are unrelated). The magnitude of the difference and hence the correlation value may determine whether the skills and abilities are strongly related (e.g., large correlation value), weakly related (e.g., small correlation value), strongly unrelated (e.g., large negative correlation value), or weakly unrelated (e.g., small negative correlation value). Other statistical methods can be utilized for determining correlations, including Pearson's correlation, Spearman's correlation, regressions, and the like.

Second, in addition to or in the alternative to statistical methods, time methods may be utilized to determine the strength, friendship, or affinity of these relationships. With time methods, if one skill or ability appears with another skill or ability in more recent profiles, then the more recent pairings or associations will be give more weight in determining the strength of relationships, friendships, and affinities. Profiles may be considered more recent than other profiles if they were created, updated, and/or accessed at a later date. According to an exemplary embodiment, relationships, friendships, or affinities between skills and abilities may “age” and disappear if they do not appear together in a particular number of new updated, or accessed profiles within a subsequent time period.

Third, in addition or in the alternative to the two methods described above, other embodiments of the present invention may determine the strength of relationships (or friendships or affinities) between skills or abilities according to frequency means. With the frequency method, the more profiles in which one skill or ability appears with another skill or ability, the stronger the relationship, friendship, or affinity between the two skills or abilities. For example, the number of profiles or the percentage of profiles in which one skill or ability appears with another skill or ability may be used to determine the strength of the relationship, friendship, or affinity between two skills or abilities. One of ordinary skill in the art will recognize that other means are readily available for determining the strength of such relationships.

Still referring to FIG. 3, once the host module 123 has determined the suggested list of related skills and abilities along with the strength of the relationships, friendships, or affinities, these related skills or abilities may be ordered according to the strength of the relationships, friendships, or affinities as determined above (block 306). The host module 123 then presents at least a portion of the related skills or abilities on the web page for selection by the job applicant (block 308). In particular, at least the list of skills or abilities with the highest or strongest relationship to the skills or abilities already entered by the job applicant will be suggested.

Now returning back to FIG. 2, the selection process in block 204 and suggestion process in block 206 described above will be repeated until the job applicant has completing entering the entire list of his or her skills or abilities (block 208). The list of suggested skills and abilities of block 206 may change in response to each selection in block 204. Thus, as the job applicant's list of skills and abilities changes, the list of related skills and abilities suggested by the host module 123 may change. Once the job applicant has finished entering his or her skills and abilities, these skills and abilities will ultimately be stored with the job applicant's profile in the database 105 on the host server 104 (block 210).

Job Applicant Example #1

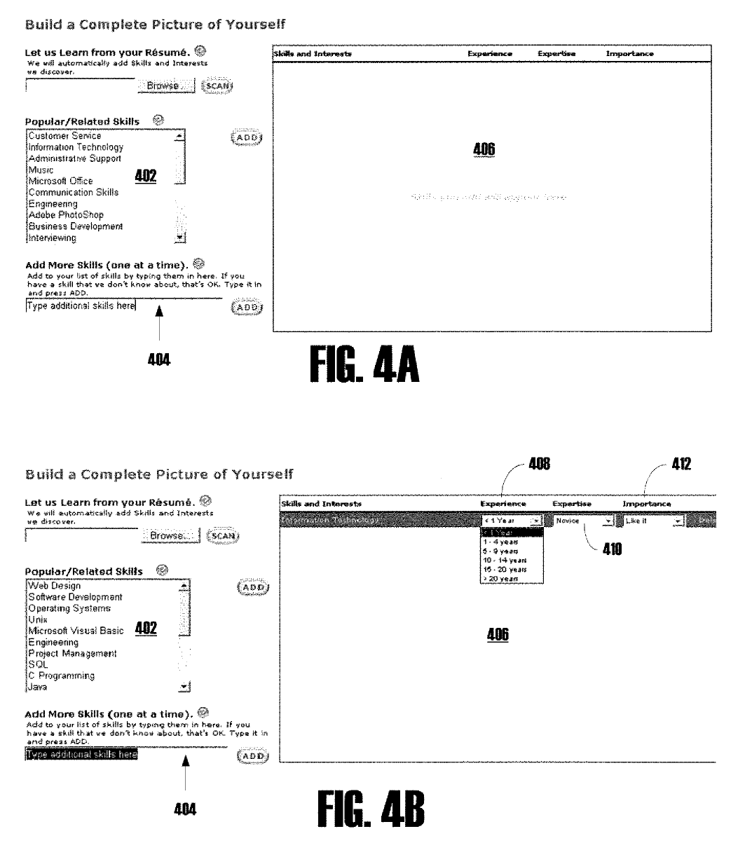

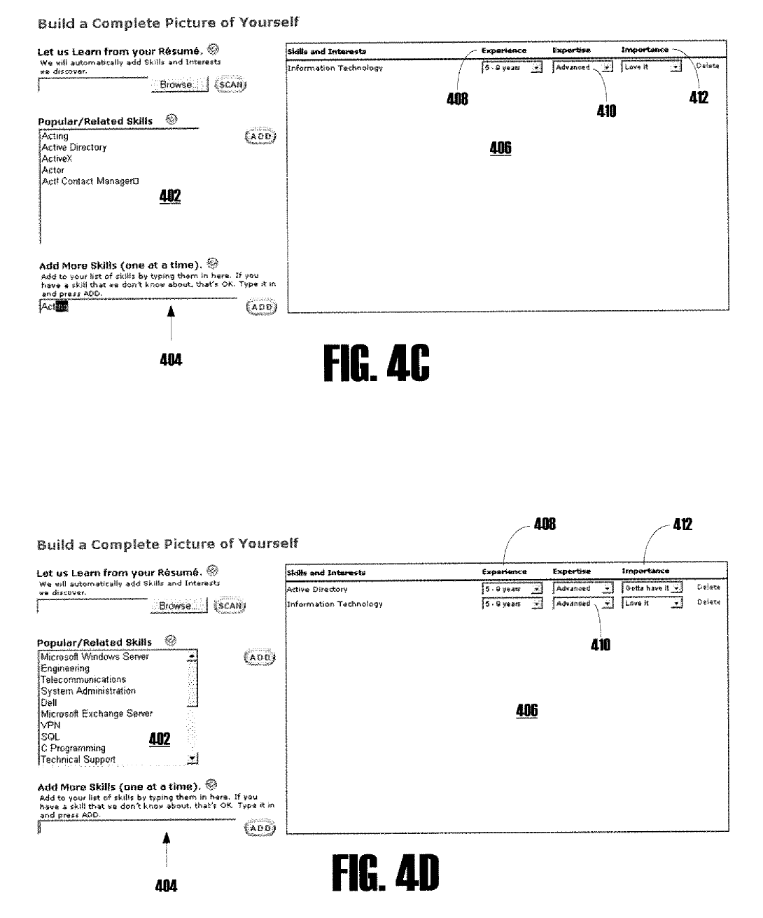

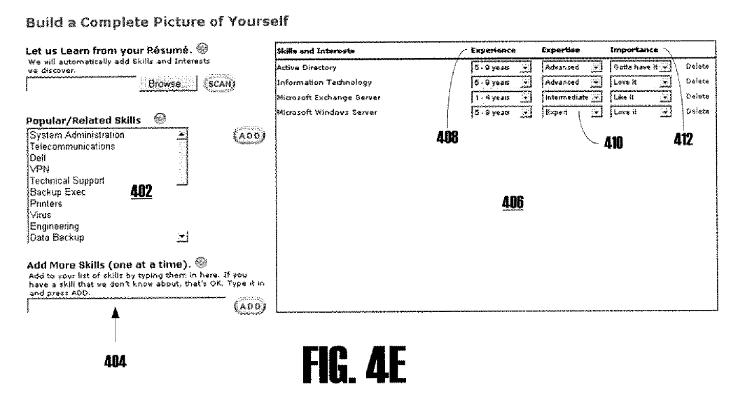

An exemplary embodiment of the present invention will now be described with respect to FIGS. 4A-4E. FIGS. 4A-4E illustrate exemplary user interfaces presented by the host module 123 to the job applicant in accordance with the block diagrams of FIGS. 2 and 3 above.

In FIG. 4A, there is a user interface that provides a suggested list of skills or interests 402, a text box 404 for specifying additional skills or interests, and a selected list of skills or interests 406. The suggested list of skills or interests 402 may initially display default commonly-entered categories of skills or interests if no skills or interests have yet been entered into the selected list 406 as shown in FIG. 4A. The text box 404 may be used to enter skills or interests that are not shown in the suggested list 402.

Once a skill or interest has been selected through the suggested list 402 or entered through the text box 404, the selected or entered skill or interest will appear in the selected list 406. As an example, in FIG. 4B, the job applicant has selected “Information Technology” from the suggested list 402, and “Information Technology” now appears in the selected list 406. At this point, the job applicant may optionally specify for this “Information Technology” skill, his or her experience 408 (e.g., number of years), expertise 410 (e.g., novice, intermediate, advanced, expert, etc.), or importance 412 (e.g., like it, love it, gotta have it, etc.). Once “Information Technology” has been specified in the selected list 406, the host module 123 updates the suggested list 402 to display skills or interests commonly-related to “Information Technology.” For example, as shown in FIG. 4B, the suggested list 402 may include Web Design, Software Development, Operating Systems, Unix, Microsoft Visual Basic, Engineering, Project Management, SQL, C Programming, Java, and others. In this suggested list 402, the skills or abilities that have the highest relationship, friendship, or affinity to “Information Technology” are displayed at the top of the list. In other words, “Web Design” may currently have a higher relationship, friendship, or affinity to “Information Technology” than does “Java.”

Still referring to FIG. 4B, if the job applicant does not find a desired skill or interest in the suggested list 402, then the job applicant can enter his or her own skill or interest in FIG. 4B. For example, in FIG. 4C, the job applicant wants to include his or her experience in “Active Directory,” which is not shown in the suggested list 402, and the job applicant therefore begins to enter the term in the text box 404. Because the host module 123 of the host server 104 has a type-ahead feature, the suggested list 402 will be populated with the most common skills or interests starting with the recognized words or portions thereof in the text box 404. One of ordinary skill in the art may recognize that the type-ahead feature may depend on the frequently-entered skills or interests found in the profiles stored in database 105. Here in FIG. 4C, the job applicant has only entered the three letters “A-c-t” before the skill “Active Directory” appears in the suggested list 402. The applicant can now select the skill “Active Directory” from the suggested list 402 and add it to the selected list 406, as shown in FIG. 4D. As shown in FIG. 4D, the selected list 406 now includes both the skills of “Active Directory” and “Information Technology.”

Referring to FIG. 4D, the suggested list 402 now contains skills or interests commonly-related to either or both of “Active Directory” and “Information Technology.” As with FIG. 4B, the top of the suggested list 402 may include skills and abilities with a higher relationship, friendship, or affinity to both “Active Directory” and Information Technology,” although other orderings may be utilized, including alphabetical orderings. As discussed above, the relationships and strength of relationships, friendships, or affinities, are determined by analyzing previous profiles stored in the database 105 that also contain the skills or interests shown in the selected list 406.

Now referring to FIG. 4E, the additional skills, “Microsoft Exchange Server” and “Microsoft Windows Server” have been included in the selected list 406. In response, the suggested list 402 is updated to display suggested skills and abilities that are related to one or more of the skills “Active Directory,” “Information Technology,” Microsoft Exchange Server,” and “Microsoft Windows Server.” The skills selected by the job applicant and stored in the selected list 406 may be saved as part of the job applicant's profile in the database 105.

While the examples shown in FIGS. 4A-4E have focused on job applicants selecting or entering skills or interests, many modifications of this are also possible. According to one embodiment, a job applicant may upload his or her resume to the host server 104, which may automatically compile a list of skills or interests for the job applicant based on the contents of the resume. In this example, any common skills or interests, as determined from the stored profiles in database 105, that are recognized in the resume would be extracted.

B. Job Applicant Example #2

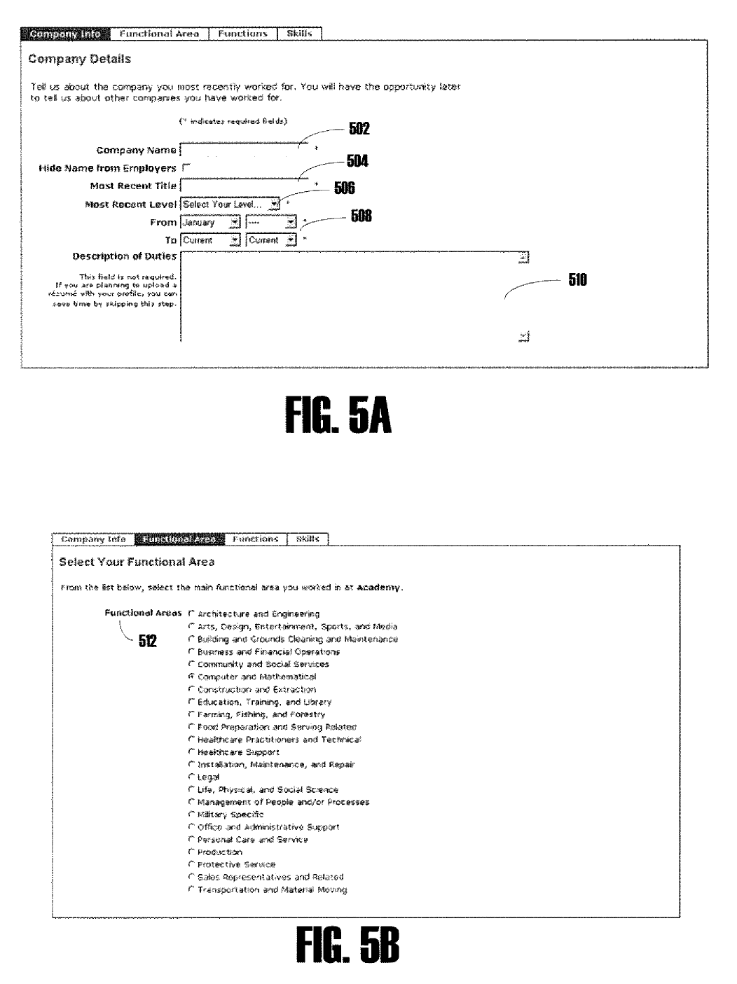

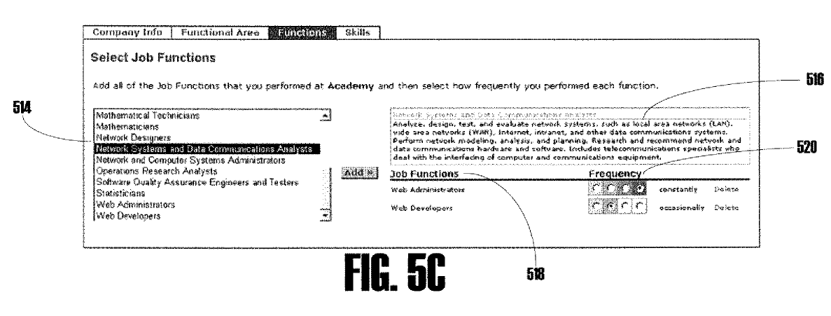

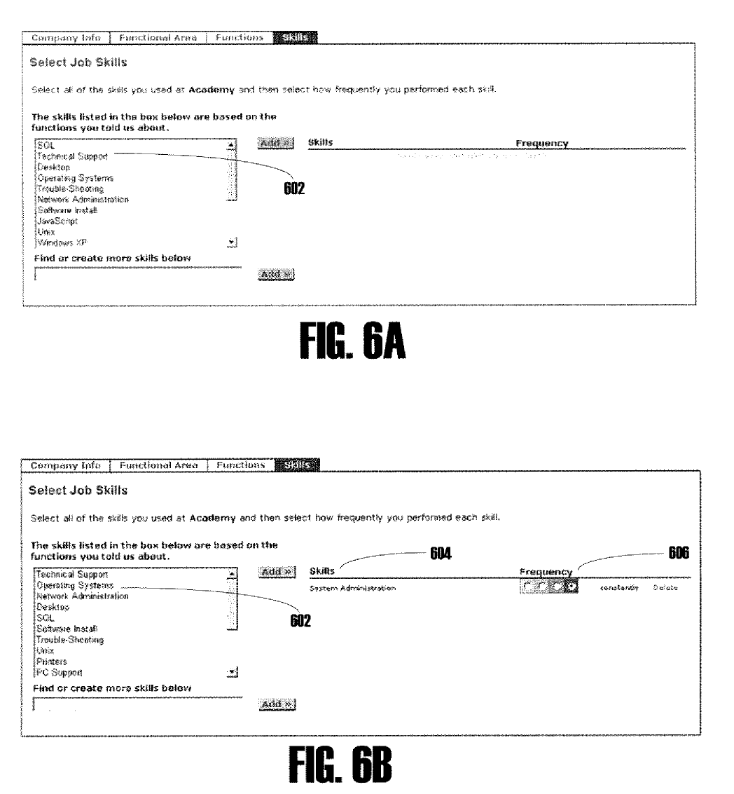

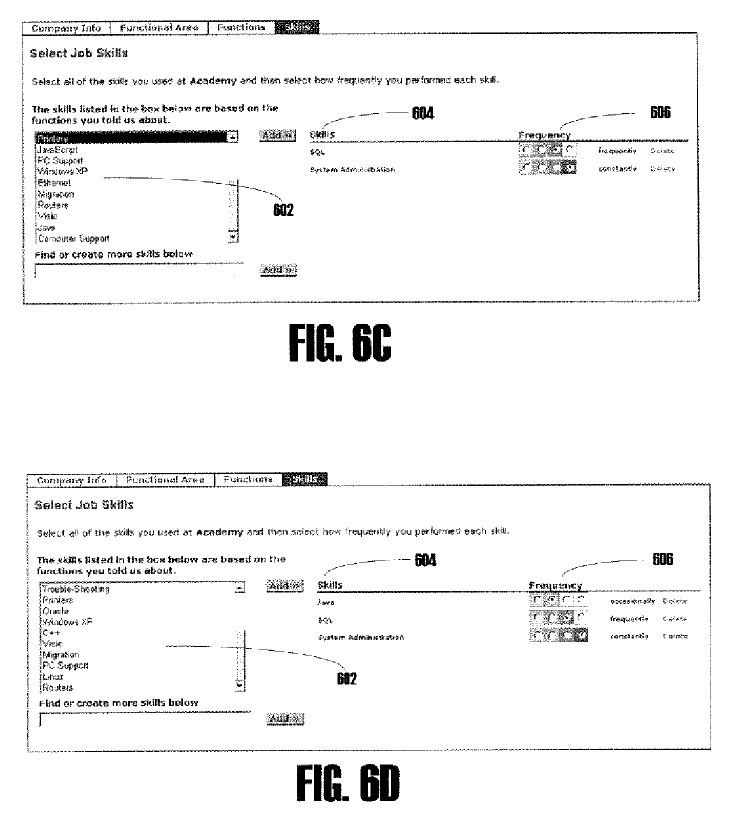

FIGS. 5-6 illustrate exemplary variations of the user interfaces presented by the host module 123 in accordance with the block diagrams shown in FIGS. 2 and 3. Referring to FIG. 5A, a job applicant may be presented with an interface for specifying the job applicant's current or previous company details. In particular, the company details can include one or more of the identity of the company 502, the job applicant's most recent title 504 at the company 502, and the job applicant's most recent level 506 at the company 502. The options for the most recent level 506 can include intern entry level, individual contributor, manager, director/VP, and executive, although other levels 506 can be specified without departing from embodiments of the present invention. The company details can also include the dates of employment 508 along with a description of duties. The company details entered by the job applicant may be stored with the job applicant's profile in the database 105.

Referring to FIG. 5B, after the job applicant provides the company details discussed above, the job applicant may be presented with a user interface for selecting one or more functional areas 512 that job applicant has worked in at the company 502. For example, the functional areas 512 can include Architecture and Engineering, Computer and Mathematical, Legal, Production, and the like. FIG. 5B illustrates an exemplary list of functional areas 512, in accordance with an illustrative embodiment of the present invention.

Once the job applicant has selected one or more functional areas 512, the user interface shown in FIG. 5C may be presented to the job applicant for selecting one or more suggested job functions 514. The list of suggested job functions 514 may be based upon the one or more selected functional areas 512 from FIG. 5B. Accordingly, the suggested job functions 514 provided on the user interface may change depending on which function area 512 has been selected by the job applicant. According to an embodiment of the present invention, the suggested job functions 514 may be a preset or predetermined listing by the host module 123 for each function area 512. According to another embodiment of the present invention, the suggested job functions 514, or the order in which they are presented, may change dynamically over time, perhaps depending upon which suggested job functions 514 appear more frequently with the selection function area 512 in stored profiles in the database 105. One or more of the suggested job functions 514 may have also have an associated description 516, which may assist the job applicant in selecting the most appropriate ones of the suggested job functions 514. Once the job applicant has selected one or more job functions 514, they will appear as selected job functions 518 on the user interface. According to an exemplary embodiment of the present invention, the job applicant can select a particular frequency 520 for each of the selected job functions 518. For example, if the job applicant's “web developers” job function 518 is performed only sporadically, then the job applicant may select a frequency 520 of “occasionally.” The options for the frequency 520 may include constantly, frequency, occasionally, seldom, and the like, although other options for the frequency 520 may be provided without departing from embodiments of the present invention.

Once the job applicant has provided the selected job functions 518, a list of suggested job skills or interests 602 will be presented to the job applicant, as shown in the user interface of FIG. 6A. As shown in FIG. 6A, the initial list of suggested job skills or interests 602 may be based at least in part upon the job skills or interests frequently found in other stored profiles in the database 105 that also have selected job functions 518. According to an exemplary embodiment of the present invention, the frequency 520 associated with each of the selected job functions 518 may impact the ordering of the list of suggested job skills or interests 602. For example, those job skills or interests 602 that are associated with job functions 518 having a frequency 520 of “constantly” may be presented before those job skills or interests 602 having a frequency 520 of seldom.

Referring to FIG. 6B, once the job applicant has selected a suggested job skills or interests 602, the user interface will display the selection as a selected job skill or interest 604. The selected job skill or interest 604 can also include an associated frequency 606. As described above, the frequency 606 may include one or more of constantly, frequently, occasionally, and seldom, although other terms or a different number of classifications may be provided for the frequency 606 without departing from embodiments of the present invention. As shown in the exemplary user interface of FIG. 6B, the selected job skill or interest 604 may be “System Administration” with a frequency 606 of “constantly.” Once a selected Job skill or interest 604 has been provided by the job applicant, the host module 123 may update the list of suggested job skills or interests 602 to reflect those job skills or interests that are related to “System Administration” based at in part on analyzing the stored profiles in the database 105. According to an exemplary embodiment of the present invention, the job skills or interests that have the highest relationship, friendship, or affinity to “System Administration” may be displayed at the top of the list.

FIG. 6C illustrates an exemplary user interface where the job applicant has additionally selected the job skill or interest 604 “SQL” with a frequency 606 of “frequently.” As shown in FIG. 6C, the suggested job skills or interests 602 may be updated by the host module 123 to reflect those job skills or interests that are related to one or both of “SQL” and “System Administration,” in accordance with an analysis of the stored profiles in the database 105. Likewise, FIG. 6D illustrates an exemplary user interface where the job applicant has additionally selected the job skill or interest 604 of “Java” with a frequency 606 of “occassionally.” As discussed above, the host module 123 may update the suggested job skills or interests 602 to reflect those skills or interests that are related to one or more of “Java,” “SQL,” and “System Administration.” The frequency 606 associated with each of the selected job skills or interests 604 may determine which of the suggested job skills or interests 602 are presented first in the list, in accordance with an exemplary embodiment of the present invention. According to an exemplary embodiment of the present invention, a higher frequency 606 (e.g., constantly) for a selected job skill or interest 604 may result in a related suggested job skill or interest 602 to be presented with a higher (e.g., more important) priority.

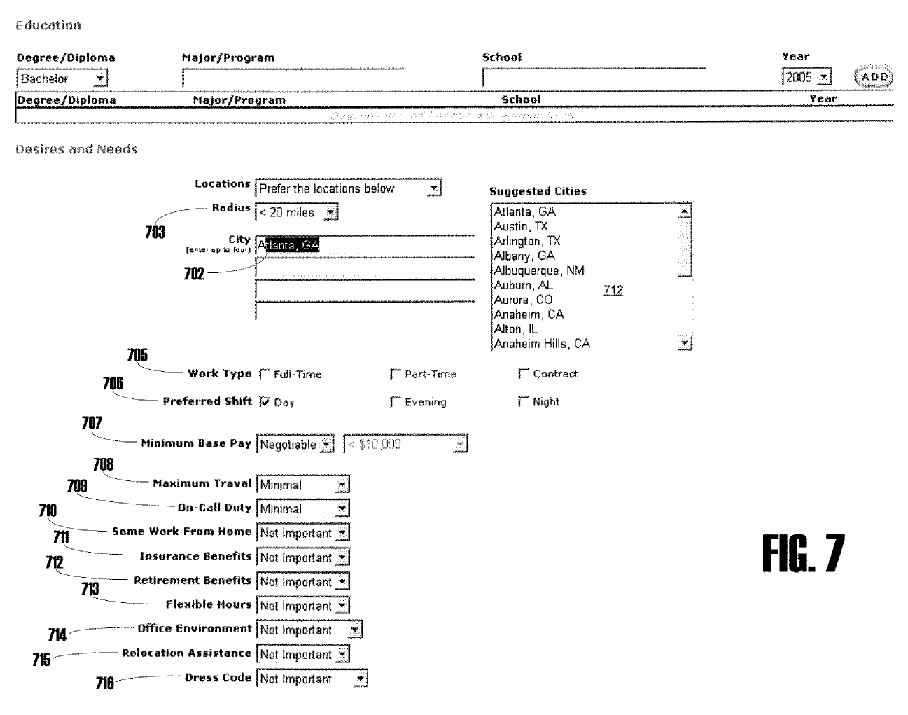

In addition to entering skills and abilities for a profile, as illustrated in the user interfaces of FIGS. 4-6, a job applicant may also enter education information and desires and needs as shown in FIG. 7. For education information, the job applicant may specify any information relating to any degrees or certifications obtained. For desires and needs, this may include preferred geographical areas, working hours, pay, benefits, and environment as shown in FIG. 7. With respect to geographical preferences, FIG. 7 shows a text box 702 for entering preferred cities along with an associated radius 703. Like the text box 404 shown in FIGS. 4A-4E, the text box 702 includes the type-ahead feature. Thus, as the job applicant begins to spell out the preferred city in the text box 702, the suggested cities list 704 will automatically display the most commonly-recognized cities beginning with the entered letters in text box 702. These most commonly-recognized cities correspond to the most frequently entered cities beginning with the entered letters in text box 702 found in profiles by other job applicants.

As shown in FIG. 7, for desires and needs, the job applicant can also specify the preferred work type 705 (e.g., full-time, part-time, contract, etc.), shift 706 (e.g., day, evening, night, etc.), minimum base pay 707, maximum travel 708, and on-call duty 709. Additionally, the job applicant can specify the importance of some work from home 710, insurance benefits 711, retirement benefits 712, flexible hours 713, office environment 714, relocation assistance 715, and dress code 716.

C: Operation of the Employment System with Recruiters

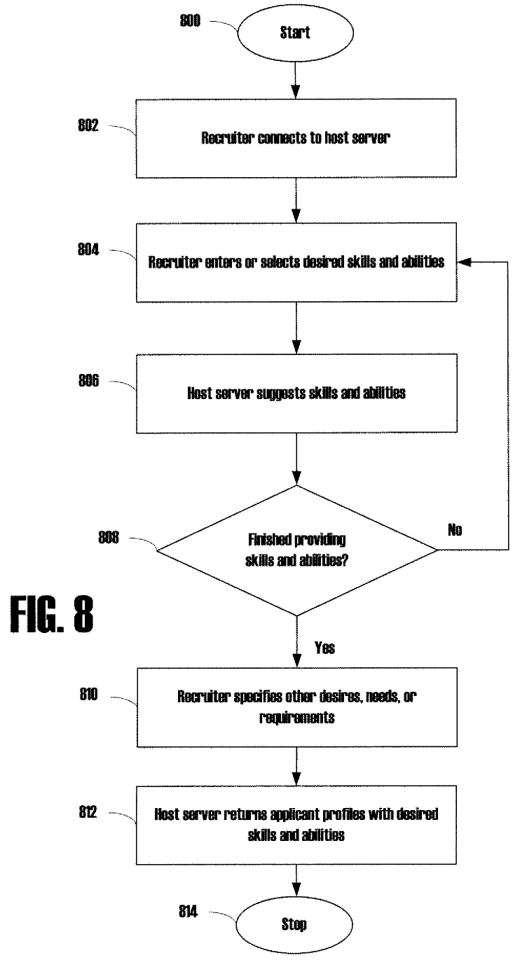

While the employment system has only been described above with respect to job applicants, the employment system similarly interacts with recruiters for finding qualified job applicants as shown in FIG. 8.

Referring to FIG. 8, the recruiter utilizes the client module 122 of the client computer 102 to communicate with the client module 123 of the host server 104 (block 802). In accordance with an exemplary embodiment of the present invention, the client module 123 may be an Internet browser communicating with an interactive web page serviced by host server 123. Once the recruiter has navigated to the web page, the recruiter will be able to specify the desired skills and abilities needed for the position the recruiter is attempting to fill (block 804). Initially, the recruiter may be able to select from a list of skills and abilities commonly-found in previous job applicants' stored profiles. Alternatively, the recruiter may enter a new skill or ability not found in the suggested list. Once the recruiter has specified one skill or ability, the host module 123 of host server 104 may suggested a list of suggested skills and abilities that are related to the specified skill or ability. As described above, this process would be similar to the one already described with respect to FIG. 3. The selection process in block 604 or the suggestion process in the block 606 will continue until the recruiter has finished provided a complete list of skills and abilities needed to fill the position (block 808). This allows a recruiter to compile a list of skills and abilities that are not only complete, but are also coherent and likely to be found in the stored profiles. In accordance with an embodiment of the present invention, the recruiter may optionally specify which additional preferences or requirements for each selected or entered skill and ability. These optional preferences or requirements may include experience (e.g., number of years), expertise (e.g., novice, intermediate, advanced, expert, etc.), or importance (e.g., like it, love it, gotta have it, etc.).

Once the recruiter has finished providing the list of skills and abilities (block 808), the recruiter may optionally specify desires, needs, or other requirements (block 810). These desires, needs, or other requirements may relate to job applicants' geographical preferences, salary preferences, work schedule preferences, benefits preferences, and perhaps others shown in the exemplary user interface of FIG. 7. One of ordinary skill in the art will recognize that the recruiters may be able to specify a variety of information that has been stored in the job applicants' profiles. Once the recruiter has finished providing the list of skills and abilities and any optional desires, needs, or other requirements, the host module 123 may present to the recruiter all job applicants that match the information provided by the recruiter. According to an exemplary embodiment of the present invention, the recruiter may not be able to view the job applicants' information. Instead, the recruiter may be able to first communicate interest to the job applicant anonymously through the employment system. For example, the recruiter may be able to communicate with the job applicant using the employment system as a proxy, perhaps through the web pages of the employment system (e.g., a mailbox provided by the employment system) or through an anonymous proxy email. Then, the job applicant has the ability to choose when, if ever, to reveal information to the recruiter. This allows the job applicant to maintain some anonymity during a job search.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for standardizing employment skill sets, comprising:
storing a plurality of profiles, wherein each profile provides a plurality of skills associated with a previous job applicant;
receiving a first skill from a current job applicant;
searching the stored profiles for profiles that include the first skill; and
determining at least one second skill in at least a portion of the profiles including the first skill, wherein the second skill is different from the first skill.

2. The method of claim 1, further comprising:
presenting at least a portion of the at least one determined second skill to the current job applicant in response to the received first skill.

3. The method of claim 1, wherein receiving a first skill from a current job applicant includes receiving the first skill from a resume uploaded by the current job applicant.

4. The method of claim 1, wherein determining at least one second skill includes determining a plurality of second skills.

5. The method of claim 4, further comprising ordering the plurality of determined second skills by a strength of relationship between each determined second skill and the first skill.

6. The method of claim 5, wherein the strength of relationship is associated with a correlation value between each determined second skill and the first skill.

7. The method of claim 5, wherein the strength of relationship is aged according to time.

8. The method of claim 5, wherein the strength of relationship is associated with each determined second skill appearing with the first skill in at least one of a particular number of stored profiles and a particular percentage of stored profiles.

9. A computerized employment system for standardizing employment skill sets, comprising:
a database that stores a plurality of profiles, wherein each profile provides a plurality of skills associated with a previous job applicant; and
a host module in communication with the database, wherein the host module is configured to:
receive a first skill from a current job applicant;
search the stored profiles in the database for profiles that include the first skill; and
determine at least one second skill in at least a portion of the stored profiles having the first skill, wherein the second skill is different from the first skill.

10. The system of claim 9, wherein the host module is further configured to present at least a portion of the at least one determined second skill to the current job applicant in response to the received first skill.

11. The system of claim 9, wherein the first skill is received from a resume uploaded by the job applicant.

12. The system of claim 9, wherein the at least one determined second skill includes a plurality of determined second skills.

13. The system of claim 9, wherein the host module is further configured to order the plurality of second skills by a strength of relationship between each determined second skill and the first skill.

14. The system of claim 13, wherein the strength of relationship is associated with a correlation value between each second skill and the first skill.

15. The system of claim 13, wherein the strength of relationship is aged according to time.

16. The system of claim 13, wherein the strength of relationship is associated with each determined second skill appearing with the first skill in at least one of a particular number of stored profiles and a particular percentage of stored profiles.

17. A method for identifying qualified job applicants, comprising:
storing a plurality of profiles in a database, wherein each profile includes a plurality of skills associated with a previous job applicant;
selecting a first skill by a recruiter;
searching the stored profiles in the database for profiles that include the first skill;
determining at least one second skill in at least a portion of the profiles having the first skill, wherein the second skill is different from the first skill;
selecting at least one determined second skill by the recruiter; and
identifying at least one stored profile based at least in part on the selected first skill and selected second skill.

18. The method of claim 17, wherein the profiles further includes at least one of a preferred geographical area, a salary preference, a work schedule preference, and a benefits preference for the previous job applicant.

19. The method of claim 17, wherein identifying at least one stored profile includes identifying at least one stored profile based at least in part on at least one of the preferred geographical area, the salary preference, the work schedule preference, and the benefits preference.

20. The method of claim 17, further comprising means for anonymous communications between the recruiter and at least one previous job applicant associated with the identified at least one stored profile.
